(19) United States
(12) Patent Application Publication
(10) Pub. No.: US 2019/0001588 A1
(43) Pub. Date: Jan. 3, 2019

(54) Method for producing structures made of thermosetting composite materials by assembling composite constituent parts moulded by injection infusion of liquid resin

(71) Applicant: Airbus SAS, Blagnac (FR)

(72) Inventors: Patrice LEFEBURE, ORVAULT (FR); Jonas BURTH, Basse Goulaine (FR)

(21) Appl. No.: 16/017,180

(22) Filed: Jun. 25, 2018

(30) Foreign Application Priority Data
Jun. 30, 2017 (FR) 1756111

(51) Int. Cl. B29C 70/30; B29C 70/06; B29C 70/54; B29C 70/46

(52) U.S. Cl. CPC B29C 70/30; B29C 70/467; B29C 70/541; B29C 70/06

(57) ABSTRACT

A method for creating a structural part made of composite material by injecting-infusing a liquid, thermosetting resin into a fibrous reinforcement, the structural part comprising a first element and at least one second element. Both the first element and the at least one second element are created in an intermediate state during a distinct injection-infusion step associated with partial curing that is arrested at a degree of cross-linking of the resin below a gelling point of the resin. The first element and the at least one second element are held in a tooling, in a relative position and in a shape that the elements are to have in the structural part to be created, during an out-of-autoclave simultaneous complete curing phase so as to obtain a desired degree of polymerization of the resin of the first element and of the resin of the at least one second element.

### CROSS-REFERENCES TO RELATED APPLICATIONS

This application claims the benefit of the French patent application No. 1756111 filed on Jun. 25, 2018, the entire disclosures of which are incorporated herein by way of reference.

### TECHNICAL FIELD

The present invention relates to the field of the manufacture of parts made of composite materials, it relates more particularly to the methods for molding of composites by injection-infusion of resin.

The present invention relates more generally to the fields of high-performance composites, of technologies for the molding of composites by injection-infusion of liquid resin, of the technologies for the assembly of composites, and of out-of-autoclave manufacturing techniques.

### BACKGROUND OF THE INVENTION

The methods for molding composites by injection of liquid resin (liquid composite molding or LCM) represent an established class of techniques for the manufacture of structural or semi-structural parts made of composite materials based on a resin that is reinforced with a fibrous reinforcement.

The known variants of the LCM methods share the same principle: a liquid resin is injected into a closed mold (RTM) or an open mold (vacuum infusion) into which a fibrous preform of dry fibres has been previously placed; after curing of the fibre-matrix mixture, that is to say after complete polymerization of the resin, a part is obtained and can be de-molded.

LCM technology is principally used in the manufacture of parts made of thermosetting composites, but it is nonetheless possible to apply such a technology to thermoplastic composites, or to other categories of resins provided that they have a liquid phase during injection into the mold.

Nowadays, manufacture using an LCM method of a stiffened composite structure, that is to say one comprising a skin and at least one substructure component such as a stiffener for example, is principally realized by injection-polymerization of the structure as a whole and in a single step.

A process of this kind implies polymerization (or infusion) of the skin with the components of the substructure of the assembly, and therefore requires complex tooling comprising numerous vents and injection lines or points, the position and number of these being difficult to optimize, complex injection-infusion equipment depending on the dimensions and geometry of the resulting parts, comprising systems of pumps and injection machines, long and difficult steps of compacting the constituent preforms, a very long overall injection-infusion and curing (polymerization) time in order to satisfy not only health requirements but also mechanical and thermomechanical requirements for the resulting structural part.

Certain solutions that are close but more disadvantageous in terms of production time and cost involve joining, to one another, injected and polymerized portions of the structural part that is to be manufactured, either by riveting or by adhesive bonding with the presence of films of interface resin, the nature of which is compatible with the injection-infusion resin of the constituent composite parts that are to be assembled.

Nonetheless, this type of assembly by adhesive bonding requires the application of pressure during the bonding phase, at high temperature, so as to ensure proper contact between the parts that are to be joined, and to be able to obtain optimal thermomechanical and mechanical properties of the adhesively bonded interface. These operations require, among other things, specific tooling to optimize the connection between the various portions of the structural part.

Furthermore, these methods for assembly by adhesive bonding (or cobonding) of separate portions of a structural part generally require the application of pressure of at least several bar, which excludes all out-of-autoclave manufacturing techniques.

These methods also require complete fabrication, that is to say injection and complete polymerization, of all of the substructure components of the stiffened structural part.

### SUMMARY OF THE INVENTION

The principal object of the present invention is to alleviate the drawbacks of the prior art by simplifying the overall process for manufacturing structural parts made of composite materials by injection-infusion of liquid resin, while improving the quality of the manufactured parts and reducing the time and cost of production. The present invention describes a method for creating a structural part made of composite material by injection of a resin into a fibrous reinforcement, the structural part comprising a first element and at least one second element.

This method is noteworthy in that both the first element and the at least one second element are created in an intermediate state during a distinct injection-infusion step associated with partial curing that is arrested at a degree of cross-linking of the resin below a gelling point of said resin, and in that said first element and said at least one second element are held in a tooling, in a relative position and in a shape that said elements are to have in the structural part to be created, during an out-of-autoclave simultaneous complete curing phase so as to obtain a desired degree of polymerization of the resin of said first element and of the resin of said at least one second element.

According to a first embodiment, the first element and the at least one second element are created in the intermediate state separately from one another.

According to a second embodiment, the first element, or the at least one second element, is created in the intermediate state in contact with the at least one second element, or respectively with the first element, previously created in the intermediate state.

Advantageously, the injection-infusion step is associated with partial curing up to a degree of cross-linking of the resin of between 25% and 50%.

According to one embodiment, the creation of the first element and/or of the at least one second element in the intermediate state comprises a step of manufacture by injection-infusion of resin into a preform of a planar plate, followed by partial curing of said planar plate, and comprises a step of cutting out and/or forming said planar plate to the dimensions and forms desired for said first element and/or said at least one second element.

More particularly, and according to the first embodiment, the method comprises, in order, the following steps, it being possible for the first step and the second step to be swapped or simultaneous, and for the third step and the fourth step to be swapped:

a step of injection-infusion of the resin into a preform of the first element, followed by partial curing of said first element;

a step of injection-infusion of the resin into a preform of the at least one second element, followed by partial curing of said at least one second element;

a step of installing, into the tooling, said at least one second element obtained in the preceding step;

a step of positioning the first pre-cured element in contact with the at least one second element installed in the tooling in the preceding step;

a step of simultaneous out-of-autoclave complete curing (or co-curing) of the first element and of the at least one second element, positioned in the preceding step, up to a desired final degree of polymerization of the resin so as to form molecular bonds between the polymer resins of the elements that are in contact, making it possible to ensure the intended mechanical and thermomechanical properties of the assembly of the two elements.

Advantageously, the out-of-autoclave complete curing step is carried out under a vacuum in a conventional oven.

More particularly, and according to the second embodiment, the method comprises, in order, the following steps:

a step of installing, into a suitable injection tooling, the at least one second injected-infused and pre-cured element produced previously;

a step of installing a fibrous preform of the first element in contact with the at least one pre-cured second element;

a step of injection-infusion of resin into the fibrous preform of the first element, accompanied by partial curing of said first element for direct assembly of the first element and the at least one second element;

a step of out-of-autoclave complete curing of the assembly obtained in the preceding step, up to a desired final degree of polymerization of the resin.

Advantageously, the step of out-of-autoclave complete curing, or post-curing, is carried out in “free” mode, without the application of a vacuum and outside the suitable tooling.

More particularly, the first element comprises a skin or a panel and the at least one second element comprises a stiffening element, or a stiffener, or a stiffening element portion.

The invention also relates to a structural part made of composite material, comprising a skin, or a panel, and at least one stiffening structure, or a portion of a stiffening structure, said structural part being manufactured using a method according to the invention.

The fundamental concepts of the invention having been presented above in their most elementary form, other details and features will emerge more clearly upon reading the following description and with regard to the appended drawings which present, by way of non-limiting example, embodiments of a method for manufacturing a part made of composite material, and of a part obtained using said method in accordance with the principles of the invention.

### BRIEF DESCRIPTION OF THE DRAWINGS

The various figures, and the elements of a single figure, are not necessarily presented at the same scale. In all of the figures, identical elements bear the same reference.

Thus, in the figures:

FIG. 1 is a perspective view of a stiffened structural part comprising a skin and a stiffener, such as can be created using a method according to the invention;

FIG. 2a is a perspective view of the stiffener of the structural part of FIG. 1;

FIG. 2b is a perspective view of a portion of the skin of the structural part of FIG. 1;

FIG. 3 shows the steps of the method according to a first embodiment of the invention;

FIG. 4 shows the steps of the method according to a second embodiment of the invention.

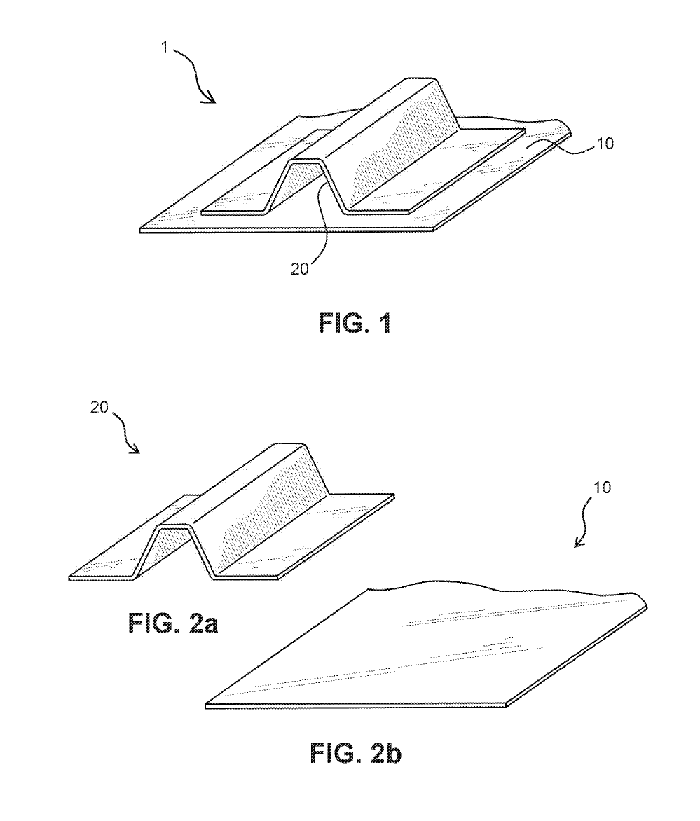

### DETAILED DESCRIPTION OF THE PREFERRED EMBODIMENTS

FIG. 1 shows, by way of non-limiting example, a structural part 1 made of composite material based on a thermosetting resin and a fibrous reinforcement, advantageously created according to the method of the invention. The structural part 1 is stiffened, that is to say that it is formed by assembling a structural envelope of the plate, panel or hull type, the skin 10, and at least one substructure element of the beam type, the stiffener 20, which cooperates with said skin in order to increase a local rigidity and/or overall mechanical strength, for example stiffness in flexion, of said structural part.

These structures, referred to as stiffened structures, are widespread in industry, and in particular in aerospace construction, they provide the desired mechanical strength while limiting the size and overall mass of the assemblies. They are frequently found in the form of stiffened composite panels in aircraft fuselage sections, for example.

In the following, any stiffened structural part made of composite material and manufactured using a method of molding by injection-infusion of liquid resin will be referred to as a stiffened LCM structural part, or more simply an LCM structure.

The structural part 1, shown in FIG. 1, is a stiffened LCM structural part created according to one of the two implementations of the method according to the invention, which are presented below.

A first implementation of the method involves curing together the pre-cured elements of the LCM structure, in other words simultaneous curing of the pre-cured skin and the pre-cured stiffeners.

A second implementation of the method involves injecting and pre-curing the skin with the pre-cured stiffeners, and carrying out out-of-autoclave post-curing of the obtained pre-cured LCM structure.

The steps of each of the variants of the method according to the invention are described below.

First embodiment: simultaneous curing of the elements, skin and stiffeners, in the pre-cured state

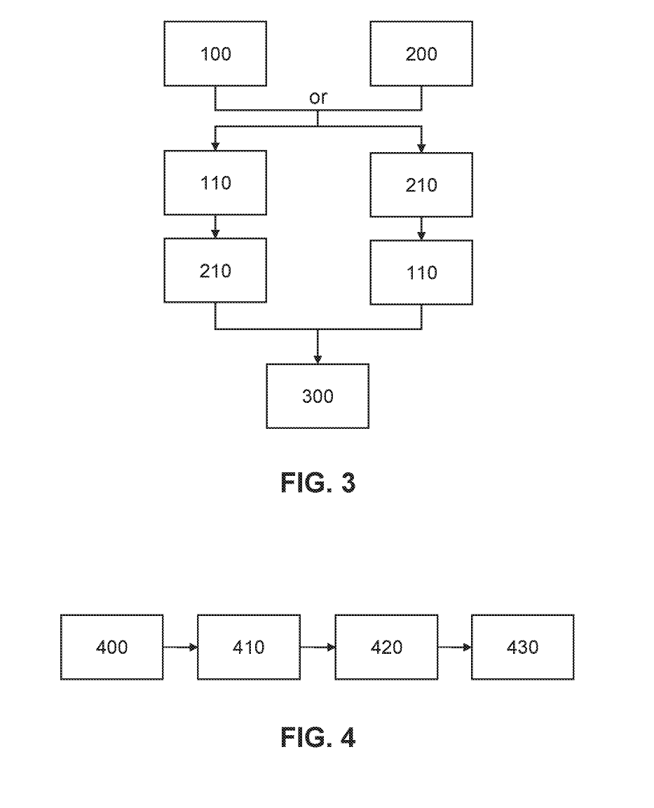

The method for manufacturing the LCM structure according to this first embodiment comprises the following steps, numbered in accordance with the references of FIG. 3:
a step 100 of injection-infusion of the resin into a preform of the skin, and of pre-curing said skin up to a degree of cross-linking of the resin of between 25% and 50%, below a gelling point of said resin. In this case, the skin is said to be semi-cured since the degree of cross-linking of its resin is close to a median level that lends the skin sufficient dimensional stability to allow it to be handled in the workshop without harming its integrity, while retaining shapeability properties and a capacity to form new inter-molecular bonds;
a step 200 of manufacturing the semi-cured stiffeners. This step can be carried out according to one of the following alternatives:
   injection-infusion of resin into fibrous preforms of stiffeners and semi-curing said stiffeners, following a method similar to that implemented for the skin;
   injection-infusion of resin into preforms of planar sheets and semi-curing of the planar composite sheets, then shaping said planar sheets so as to obtain semi-cured stiffeners using a forming process of the thermoforming type for thermoplastic sheets (French patent application having the title “Method for manufacturing thermosetting composite parts by forming injected or infused fibrous preforms”, of which one of the inventors is Patrice Lefebure);
a step 210 of installing semi-cured stiffeners, obtained in step 200, into a suitable tooling, maintaining the desired shapes of the stiffeners;
a step 110 of positioning the semi-cured skin in direct contact with the stiffeners installed in the tooling in step 210, said tooling also maintaining the desired shape of the skin;
a step 300 of complete, out-of-autoclave curing of the assembly of the skin and the stiffeners, obtained in step 110, up to a desired final degree of polymerization for the finished structural part.

According to this first embodiment of the method, the order in which the various steps are cited in no way defines a single sequence for the execution of said method, it being possible for certain steps to be swapped or carried out simultaneously, in particular steps 100 and 200.

The step 300 of complete curing of the LCM structure in the semi-cured state is carried out for example under a vacuum in a conventional oven, the vacuum being used only to ensure intimate contact between the pre-cured elements that are to be assembled and cured.

Second embodiment: injection and semi-curing of the skin with the semi-cured stiffeners, and post-curing of the LCM structure

The method for manufacturing the LCM structure according to this second approach comprises, in order, the following steps:
a step 400 of installing, in a suitable injection tooling, the previously prepared semi-cured stiffeners;
a step 410 of installing, into the injection tooling, a fibrous preform of the skin in contact with surfaces (soles) of the stiffeners for connecting the latter with said skin;
a step 420 of injection-infusion of resin into the fibrous preform forming the skin, accompanied by semi-curing of said infused-injected skin, up to a median degree of cross-linking, at a low average temperature that does not substantially change the degree of cross-linking of the resin of the stiffeners. During this step, the resin of the skin forms connections with the resin of the stiffeners and is brought up to a degree of cross-linking close to that of the resin of the stiffeners. This makes it possible to obtain a semi-cured stiffened LCM structure;
a step 430 of complete out-of-autoclave curing of the LCM structure obtained in step 420, up to a desired final degree of polymerization which provides optimal thermomechanical and mechanical properties.

The post-curing step can be carried out outside the tooling and without necessitating the application of a vacuum, for example by bagging. In this case, post-curing is said to be “free”.

The method for manufacturing stiffened LCM structural parts thus described can easily be used in a production site, by virtue of the implementation of a specific assembly line, for the manufacture of, for example, composite panels for wing boxes, central boxes, fuselage panels, vertical stabilizers and similar structures.

In this case, the assembly line must be broken down into multiple stations according to the implementation of the method.

Furthermore, the arrangement of the various stations in the assembly line, as well as the progression of the structural elements to be assembled, must take into account the geometry, the dimensions and the nature of the materials of said structural elements.

For example, an assembly-line suitable for the implementation of the method of the invention comprises the following stations:
a tooling and preparation station, for operations of injection, curing and post-curing;
an assembly station, which depends on the chosen variant of the method, whether injection-curing or simultaneous curing, this can be:
   a station for assembly by injection, comprising suitable equipment for injection and for vacuum application, and also comprises:
      an auxiliary free post-curing station
or
   a station for assembly by simultaneous curing of pre-cured parts, comprising a complete curing oven;
a non-destructive testing (NDT) station.

The organisation of these various stations must make it possible to maximize the gain in terms of time. Transport of the parts between stations can for example be automated.

An assembly line with which it is possible to implement the method according to the invention can be incorporated into or adapted to any site for the production of parts made of composite materials using LCM methods, in various ways following basic expertise in industrial processes.

An assembly line of this kind is advantageous in that it permits a gain in terms of productivity and delivery times, a gain in terms of tooling costs and auxiliary products, a substantial reduction in waste, savings by virtue of the non-use of autoclaves, and the possibility of subcontracting certain preliminary operations for the manufacture of parts, and overall a reduction in ongoing and one-off costs.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for creating a structural part made of composite material by injection-infusion of a resin into a fibrous reinforcement, the structural part comprising a first element and at least one second element, comprising:
creating both the first element and the at least one second element in an intermediate state during a distinct injection-infusion step associated with partial curing that is arrested at a degree of cross-linking of the resin below a gelling point of said resin;
holding said first element and said at least one second element in a tooling, in a relative position and in a shape that said elements are to have in the structural part to be created, during an out-of-autoclave simultaneous complete curing phase so as to obtain a desired degree of polymerization of the resin of said first element and of the resin of said at least one second element.

2. The method according to claim 1, wherein the first element and the at least one second element are created in the intermediate state separately from one another.

3. The method according to claim 1, wherein the first element, or the at least one second element, is created in the intermediate state in contact with the at least one second element, or respectively with the first element, previously created in the intermediate state.

4. The method according to claim 1, wherein the injection-infusion step is associated with partial curing up to a degree of cross-linking of the resin of between 25% and 50%.

5. The method according to claim 1, wherein creation of at least one of the first element or the at least one second element in the intermediate state comprises a step of manufacture by injection-infusion of resin into a preform of a planar sheet, followed by partial curing of said planar sheet, and comprises a step of at least one of cutting out or forming said planar sheet to dimensions and forms desired for at least one of said first element or said at least one second element.

6. The method according to claim 1, further comprising the following steps, it being possible for a first step and a second step to be swapped or simultaneous, and for a third step and a fourth step to be swapped:
injecting-infusing the resin into a preform of the first element, followed by partial curing of said first element;
injecting-infusing the resin into a preform of the at least one second element, followed by partial curing of said at least one second element;
installing, into the tooling, said at least one second element obtained in the preceding step;
positioning the first pre-cured element in contact with the at least one second element installed in the tooling in the preceding step;
simultaneous out-of-autoclave complete curing of the first element and of the at least one second element, positioned in the preceding step, up to a desired final degree of polymerization of the resin so as to form molecular bonds between the resins of the elements that are in contact.

7. The method according to claim 5, in which the out-of-autoclave complete curing step is carried out under a vacuum in a conventional oven.

8. The method according to claim 1, comprising, in order, the following steps:
installing the at least one second pre-cured element previously prepared in a suitable injection tooling;
installing a preform of the first element in contact with the at least one second element;
injecting-infusing resin into the preform of the first element, accompanied by partial curing of said first element for direct assembly of the first element and the at least one second element;
out-of-autoclave complete curing of the assembly obtained in the preceding step, up to a desired final degree of polymerization of the resin.

9. The method according to claim 8, wherein the step of out-of-autoclave complete curing is carried out without application of a vacuum and outside the suitable tooling.

10. A method according to claim 1, wherein the first element comprises a skin and the at least one second element comprises a stiffening element.

11. A structural part made of composite material, comprising a skin and at least one stiffening element manufactured using a method according to claim 1.
